(19) United States
(12) Patent Application Publication
(10) Pub. No.: US 2008/0018946 A1
(43) Pub. Date: Jan. 24, 2008

(54) Facsimile device

(75) Inventors: Takafumi Higuchi, Matshmoto-shi (JP); Shunsuke Kobayashi, Shiojiri-shi (JP); Yasumasa Nakajima, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/784,272

(22) Filed: Apr. 5, 2007

(30) Foreign Application Priority Data
Apr. 6, 2006 (JP) 2006-104780

(51) Int. Cl. H04N 1/00

(52) U.S. Cl. 358/400

(57) ABSTRACT

There is provided a facsimile apparatus that analyzes an image of a received original, and prints an image, which is different according to analysis results, in combination with the received original, thereby allowing a user to easily sort the received original. The facsimile apparatus includes communication means that transmits and receives facsimile data via a communication line, analyzing means that analyzes received image data generated on the basis of the received facsimile data, composite image data generating means that acquires ornamental image data according to analysis results of the received image data, and generates composite image data on the basis of the acquired ornamental image data and the received image data, and composite image printing means that makes a printing unit print a composite image on the basis of the composite image data.

The entire disclosure of Japanese Patent Application No. 2006-104780, filed Apr. 4, 2006 is expressly incorporated by reference herein.

### BACKGROUND

1. Technical Field

The present invention relates to a facsimile apparatus.

2. Related Art

In the related art, a facsimile apparatus has been utilized for correction of questions in correspondence education, collection of various kinds of questionnaires, etc. A facsimile apparatus that analyzes image data of replies to a questionnaire received, automatically counts the replies if preset counting termination conditions (for example, Time limit: till PM 8:00; Number-of-cases limit: up to 100 persons in order of arrival, etc.) are satisfied, and prints a count result report, is described in Patent Document 1. According to the facsimile apparatus, the count result report can also be transmitted to a separate facsimile apparatus designated. However, according to this facsimile apparatus, if it is necessary for a person to manually sort printed individual questionnaire sheets, the operation of sorting the questionnaire sheets according to answers is very troublesome. If sorting can be made without reading the answers one by one, the working hours required for the sorting can be shortened, and the occurrence frequency of artificial mistakes can also be suppressed.

### SUMMARY OF THE INVENTION

Accordingly, the object of the present invention is to provide a facsimile apparatus that analyzes an image of a received original, and prints an image, which is different according to analysis results, in combination with the received original, thereby allowing a user to easily sort the received original.

In order to achieve the above object, a facsimile apparatus of the present invention includes: communication means that transmits and receives facsimile data via a communication line; analyzing means that analyzes received image data generated on the basis of the received facsimile data; composite image data generating means that acquires ornamental image data according to analysis results of the received image data, and generates composite image data on the basis of the acquired ornamental image data and the received image data; and composite image printing means that makes a printing unit print a composite image on the basis of the composite image data.

According to this facsimile apparatus, since a template that is different according to analysis results of received image data is printed in combination with received image data, a user can easily sort printed received originals.

In the facsimile apparatus for achieving the above object, the analyzing means may analyze on the basis of identification information an identification mark region that is included in the received image data to identify the type of a transmission original form. The composite image data generating means may acquire the ornamental image data corresponding to analysis results of the identification mark region.

According to this facsimile apparatus, since ornamental image data that is different according to identification marks included in received image data is printed in combination with the received image data, a user can easily sort printed received originals.

In the facsimile apparatus for achieving the above object, the analyzing means may acquire an analysis pattern corresponding to the analysis results of the identification mark region, and may analyze regions to be analyzed outside the identification mark region of the received image data, on the basis of the acquired analysis pattern. The composite image generating means may generate composite image data on the basis of the ornamental image data and the received image data corresponding to analysis results of the regions to be analyzed.

According to this facsimile apparatus, regions to be analyzed outside an identification mark region are analyzed on the basis of an analysis pattern corresponding to the analysis result of the identification mark region, and ornamental image data that is different according to the analysis results of the regions to be analyzed is printed in combination with received image data. Thus, even if a user does not read the contents of printed received originals one by one so as to confirm them, the user can easily sort the received originals.

The facsimile apparatus for achieving the above object may further includes input means that allows the ornamental image data to be input thereto and allowing matching between the identification information and the ornamental image data to be input thereto. The analyzing means may analyze the received image data on the basis of the matched identification information and analysis pattern. The composite image data generating means may generate composite image data on the basis of the matched ornamental image data and received image data.

According to this facsimile apparatus, since a user can input ornamental image data, the user can make arbitrary ornamental image data composed with received image data. Further, since the user can input matching among ornamental image data, identification information, and analysis patterns, the ornamental image data and received image data can be printed in arbitrary combinations corresponding to the analysis results of the received image data.

The facsimile apparatus for achieving the above object may further include transmission image data generating means and transmission image data output means. The input means may allow first transmission image data wherein regions to be analyzed other than the identification mark region are laid out to be input thereto, and may allow matching among the input first transmission image data, an analysis pattern of the first transmission image data, the ornamental image data, and the identification information to be input thereto. The transmission image data generating means may generate second transmission image data on the basis of the identification mark region and the first transmission image data, and on the basis of the identification information matched with the first transmission image data. The transmission image data output means may make the printing unit print an image corresponding to the second transmission image data.

According to this facsimile apparatus, a transmission original serving as pre-arrangement for utilizing a scheme of composing and printing ornamental image data, which is different according to the contents of received originals, to thereby facilitate sorting of the received originals, can be created and printed.

In the facsimile apparatus for achieving the above object, the transmission image data output means may transmit the second transmission image data to the communication means.

According to this facsimile apparatus, a transmission original serving as pre-arrangement for utilizing the structure of composing and printing ornamental image data, which is different according to the contents of received originals, to thereby facilitate sorting of the received originals, can be created and can be distributed via the communication means.

In addition, the functions of a plurality of means included in the present invention are realized by hardware resource in which a function is specified in a configuration itself, hardware resources in which a function is specified by a program, or combinations thereof. Further, the functions of the plurality of means are not limited to those which are realized by hardware resources in which the functions are physically independent from one another. As well as the present invention can be specified as an invention of an apparatus, the present invention can be specified as an invention of a program, an invention of a recording medium on which a program is recorded, and an invention of a method.

### BRIEF DESCRIPTION OF THE DRAWINGS

FIG. 1 is a schematic diagram showing printing according to one embodiment of the present invention.

FIG. 2 is a block diagram of a facsimile apparatus according to one embodiment of the present invention.

FIG. 3 is a schematic diagram showing an example of ornamental image data according to one embodiment of the present invention.

FIG. 4 is a schematic diagram showing an example of a script according to one embodiment of the present invention.

FIG. 5 is a view illustrating printing based on the script according to one embodiment of the present invention.

FIG. 6 is a schematic diagram showing an example of a transmission original form according to one embodiment of the present invention.

FIG. 7 is a view showing screen change according to one embodiment of the present invention.

FIG. 8 is a view showing screen change according to one embodiment of the present invention.

FIG. 9 is a schematic diagram according to one embodiment of the present invention.

FIG. 10 is a schematic diagram of a table according to one embodiment of the present invention.

FIG. 11 is a flowchart according to one embodiment of the present invention.

### DETAILED DESCRIPTION

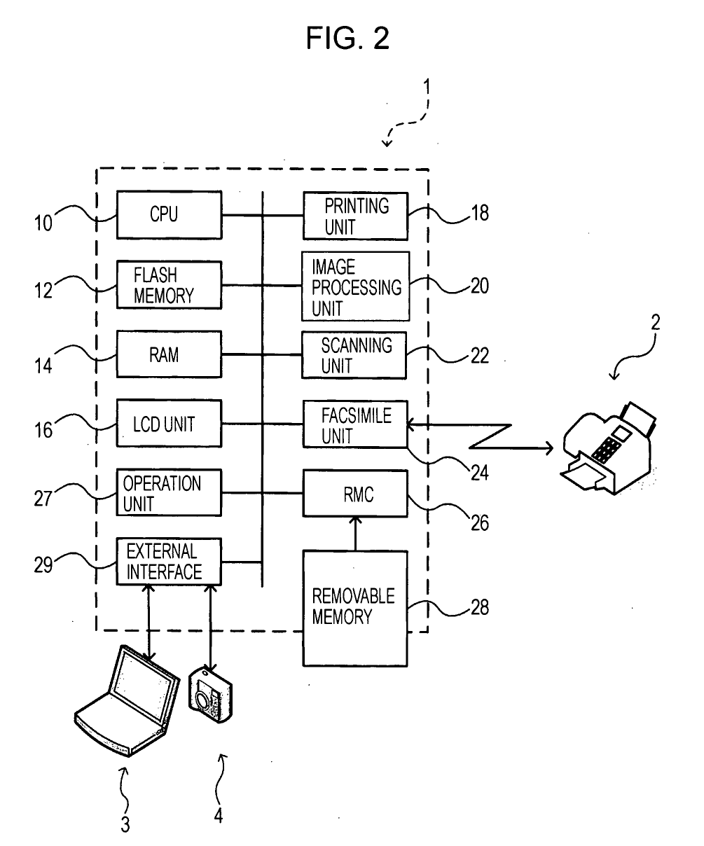

Hereinafter, an embodiment of the present invention will be described on the basis of examples. FIG. 2 is a block diagram showing a multifunction printer (MFT) 1 to which a facsimile apparatus according to the present invention is applied. The MFT 1 has a printing function, a copying function, a scanning function, and a facsimile function.

A CPU 10 as analyzing means, composite image data generating means, composite image printing means, transmission original form image data generating means, and transmission original form output means executes programs stored in a flash memory 12 to control individual units of the MFT 1. The programs can also be stored in the flash memory 12 by downloading via a network from a predetermined server, reading from computer-readable storage media, such as a removable memory 28, etc. The flash memory 12 is a nonvolatile storage medium.

A RAM 14 is a volatile storage medium, such as an SDRAM, in which a control program, processing target data of the CPU 10, and image data are temporarily stored.

An LCD unit 16 includes a liquid crystal panel (not shown) and its driving circuit.

An operation unit 27 as input means includes a plurality of keys that allow requests from a user, such as a printing request, a facsimile transmission request, and a scanning request, to be input to the MFT 1.

An external interface 29 as input means and transmission original form output means is an input-output device that controls communication between the MFT 1, and external systems, such as a personal computer (PC) 3 and a digital still camera (DSC) 4, as external recording media, and includes a USB connector, a USB controller, etc. A controller that controls Bluetooth and IrDA communication may be provided. A user of the PC 3 and the DSC 4 can input a printing request of image data to the MFT 1 via the PC 3 and the DSC 4. When a printing request of image data is input from the PC 3 and the DSC 4, the image data held by the PC3 and the DSC4 is input to the MFT 1, and the MFT 1 executes printing on the basis of the input image data.

A removable memory controller (RMC) 26 as input means and transmission original form output means is an input-output device that reads the image data stored in the removable memory 28 as an external recording medium connected to a connector (not shown), or writes image data, etc. in the removable memory 28.

A facsimile unit 24 as communication means has a modem that performs modulation/demodulation of transmission and reception data of an NCU (Network Control Unit) for connection with a public telephone network, a protocol control unit that performs protocol control according to ITU-T recommendation, a buffer memory that temporarily stores transmission and reception data, etc. The facsimile unit 24 transmits facsimile data to a facsimile apparatus 2 via a public telephone network, and receives facsimile data from the facsimile apparatus 2 via the public telephone network. Monochrome facsimile data are binary image data based on a G3 facsimile, etc., and color facsimile data are image data in a JPEG format.

A scanning unit 22 as input means includes a linear image sensor, a driving circuit of the linear image sensor, and an illuminating device, an imaging optical system, an AD converter, etc. In addition, the scanning unit 22 may be of the flat bed type, the sheet feed type, or the handicap type. The linear image sensor may be of the contact type, or the lens reduction type. The image processing unit 20 as composite image printing means and transmission original form output means is a DSP that executes gamma correction, resolution conversion, plate dividing processing, half toning, interlace processing, etc. that generate print data from image data, at high speed.

A printing unit 18 includes a recording head that forms an image on a sheet using an ink-jet method, a drive mechanism that reciprocates the recording head, a sheet feed/ejection mechanism, etc. The printing method of a printing unit 18 may be a laser method, a thermal method, a dot impact method, etc. The hardware configuration has been described hitherto.

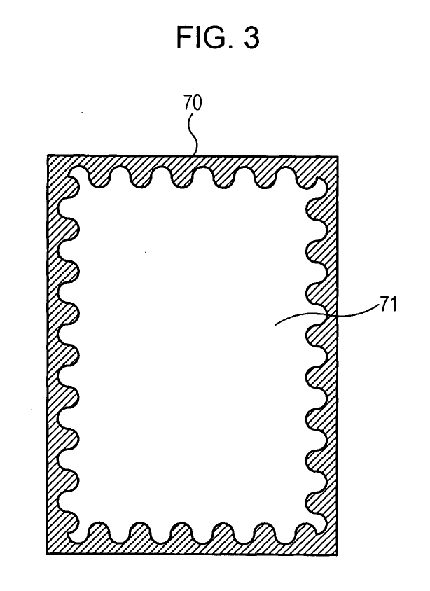

Next, the ornamental image data will be described. FIG. 3 is a schematic diagram showing an example of the ornamental image data. On the ornamental image data 70, a composition region 71 where arbitrary images are composed is defined. The composition region 71 is defined by region definition information that is added to the ornamental image data 70 (not shown). The region definition information is information on each of the pixels of the ornamental image data 70 that shows whether or not the pixel is a pixel that constitutes the composition region 71. The region definition information may be given to the pixels of the ornamental image data 70, respectively, and may be stored in a file separate from the ornamental image data 70. In addition, the region definition information may be so-called α-channel data showing the transmittance of each of the pixels that constitute the ornamental image data 70. If the region definition information is the α-channel data, pixels of image data to be targeted and the pixels of the ornamental image data 70 are composed at a ratio based on a transmittance.

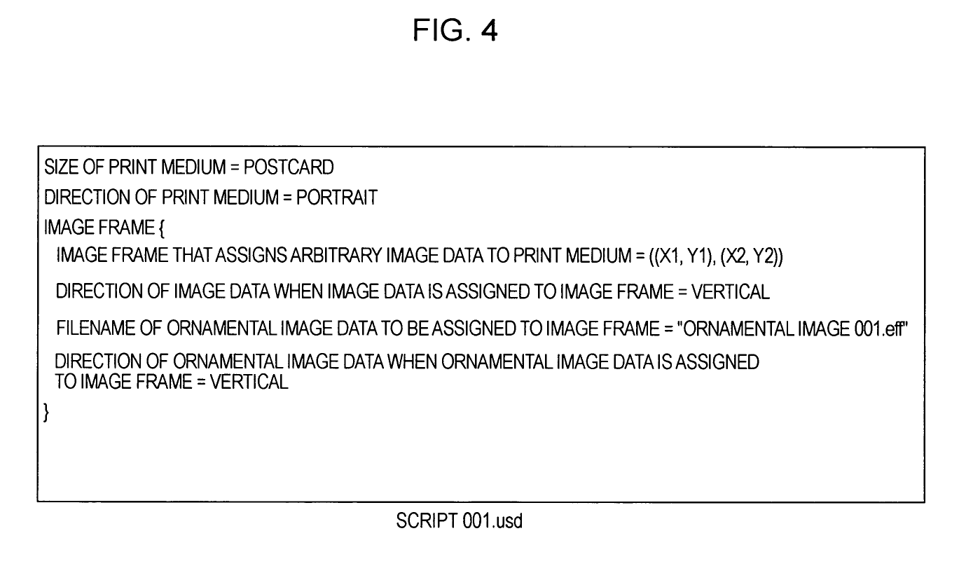

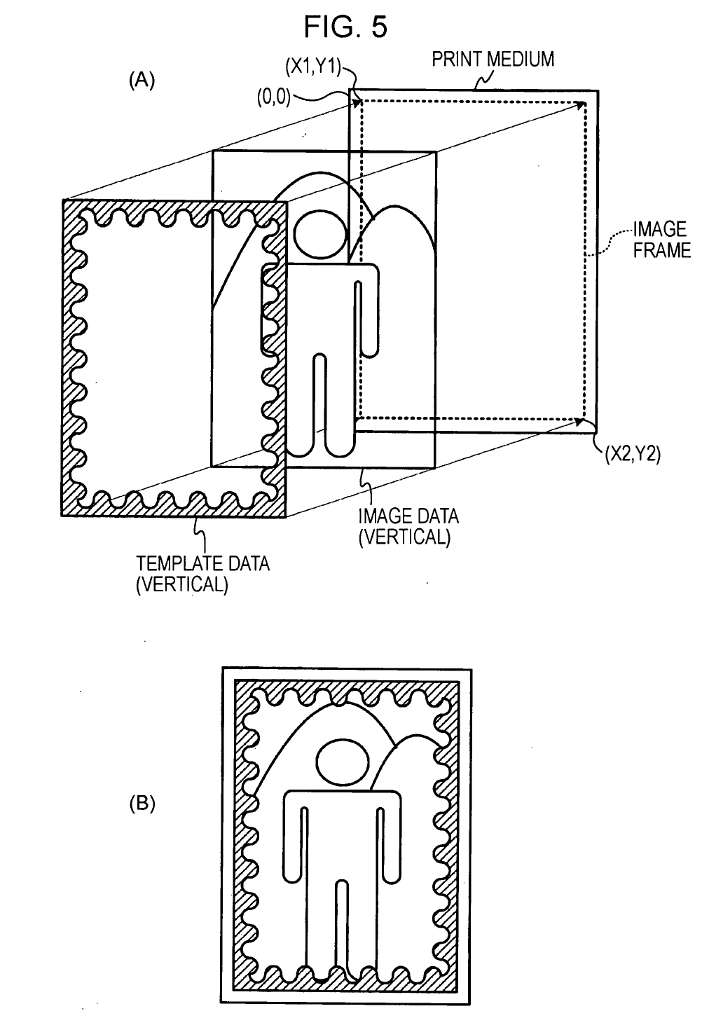

Next, a script in which the definition information that allows composite image data to be generated is described will be explained. FIG. 4 is a schematic diagram showing an example of the script. FIG. 5A is a schematic diagram illustrating printing based on the script shown in FIG. 4, and FIG. 5B is a schematic diagram showing a result printed on the basis of the script shown in FIG. 4. As shown in FIG. 4, for example, the size (for example, “postcard”) of a print medium, the arrangement (for example, “portrait”) of the print medium, an image frame (for example, an upper right coordinate (X1, Y1) and a lower left coordinate (X2, Y2) of the frame) that assigns arbitrary image data to the print medium, the direction (for example, “vertical”) of the image data when the image data is assigned to the image frame, a file name (for example, “ORNAMENTAL IMAGE 001.eff”) of ornamental image data to be assigned to the image frame, the direction (for example, “vertical”) of the ornamental image data when the ornamental image data is assigned to the image frame, etc. are defined in the script. The image frame defines a layout that assigns arbitrary image data to a print medium. That is, as shown in FIG. 4, the script is information that defines a template image in which arbitrary image data is composed, and also information that defines a layout that assigns arbitrary image data to a print medium. In addition, as the script, a script created and distributed by a manufacturer of the MFT 1 can also be used, and a script freely created by a user can also be used. Further, the script may be described in a language peculiar to the MFT 1, and may be described in a standardized language, such as XHTML or XML.

As shown in FIGS. 5A and 5B, the image data is composed in a composition region of ornamental image data assigned to an image frame to which image data is assigned, and the composed image data is assigned to the image frame.

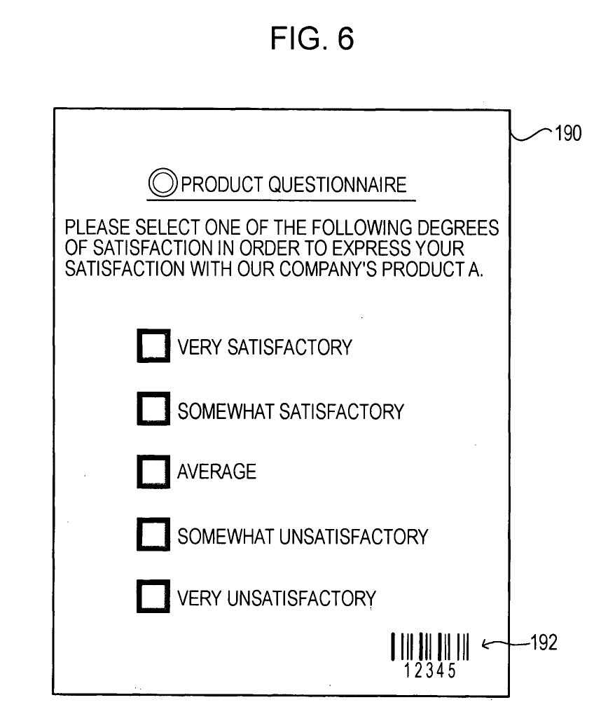

Next, the transmission original form will be described. FIG. 6 is a schematic diagram showing an example of the transmission original form. A bar code image 192 as an identification mark is assigned to a questionnaire form 190 as the transmission original form. There are various kinds of bar code standards, and a bar code to be used in the present embodiment is not limited to any one standard, and may be generated according to a unique rule. In this regard, the rule used to generate a bar code assigned to the questionnaire form 190 is stored in advance in the flash memory 12 so that it can be used as identification information by the CPU 10. The rule may be input to the MFT 1 via the RMC 26 or the external interface 29. The questionnaire form 190 is created using, for example, a predetermined questionnaire-form creating application that operates in the PC3. The questionnaire-form creating application has a function of generating a bar code according to a bar code rule that is common to the MFT 1, and assigning it to questionnaire form image data. Further, in the questionnaire-form creating application, the positions of regions to be analyzed including a plurality of checkboxes that are targets to be analyzed are determined in advance so as to match the number of questions of a questionnaire, the number of checkboxes for every question item, etc. In addition, the identification mark may be two-dimensional codes or other marks.

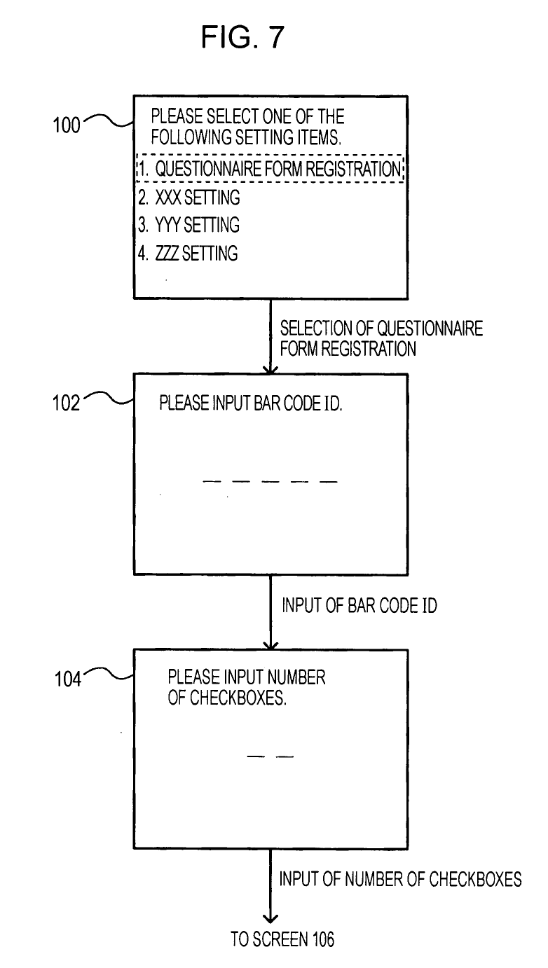

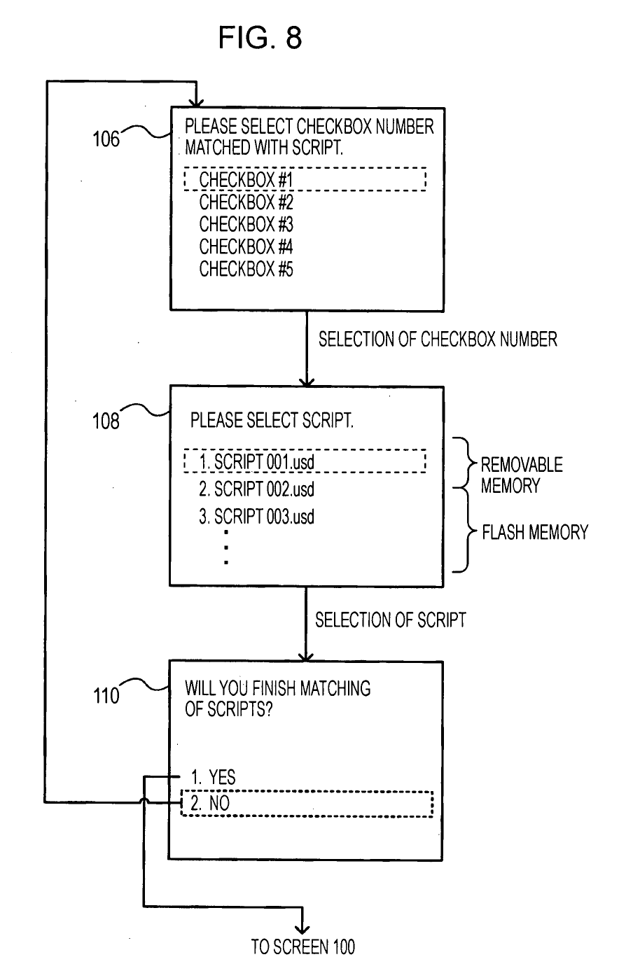

FIGS. 7 and 8 are views showing an example of screen change for registering matching between the type of questionnaire forms, and the ornamental image data. A screen 100 is a screen that allows setting items to be selected. When “1. QUESTIONNAIRE FORM REGISTRATION” is selected in a state where this screen is displayed, the CPU 10 makes the current screen change to a screen 102. The screen 102 is an example of screens that allow input of identification information (bar code ID) that allows the type of a questionnaire form that composes the ornamental image data to be identified. The screen 102 is, for example, a screen that urges a user to input an identification number using a ten-key pad (not shown). When the user inputs a bar code ID, the CPU 10 makes the current screen change to a screen 104.

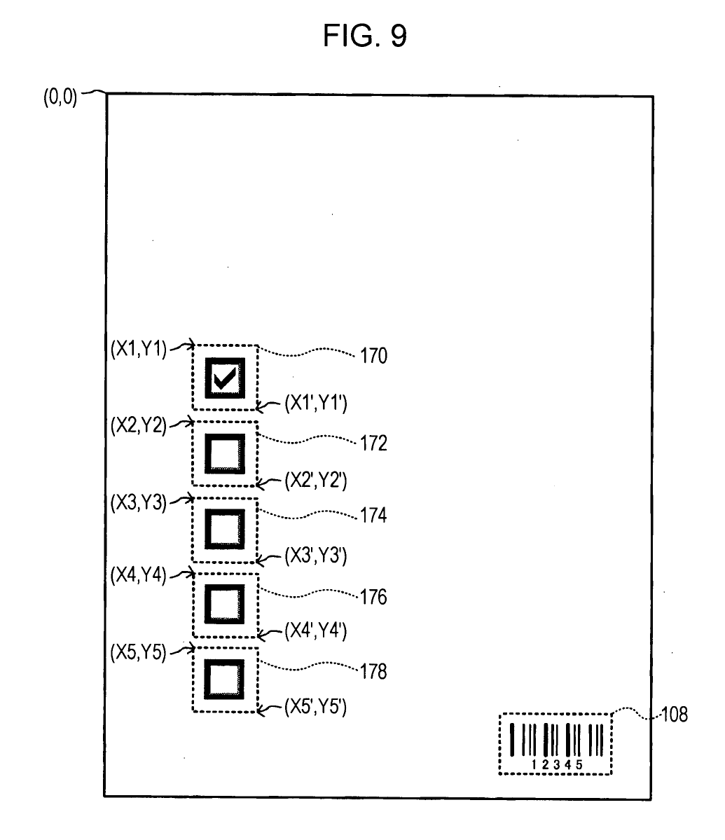

The screen 104 is a screen that allows the number of a checkbox to be input thereto. When the number of checkboxes is input, an analysis pattern is determined. That is, for example, when “5”, is input as the number of checkboxes, five regions 170, 172, 174, 176, and 178 as shown in FIG. 9 are set as the regions to be analyzed. According to the number of questions in a questionnaire, etc., more detailed setting can be made. On the screen 104, the number of checkboxes is not input, but a layout pattern of checkboxes may be listed and displayed on the screen so that a checkbox can be selected by a user. When an analysis pattern is determined even if any interface is adopted, the CPU 10 makes the current screen change to a screen 106.

Screens 106, 108, and 110 are screens that match scripts with checkboxes. A user can freely register matching, including matching different scripts with all the checkboxes or matching a script with a specific checkbox. A list of file names of scripts stored in the flash memory 12 and a list of file names of scripts stored in the removable memory 28 are displayed on the screen 108. In addition, for example, if the screen can be connected with a communication network, file names of scripts stored in a predetermined server may be displayed on the screen. When display of the scripts stored in the removable memory 28 or server are attempted, the number of scripts to be selected can be more freely increased. Further, as already described, the file name of ornamental image data is indicated in a script. Thus, when a bar code ID, an analysis pattern, and a script are matched, the ornamental image data to be composed will also be matched.

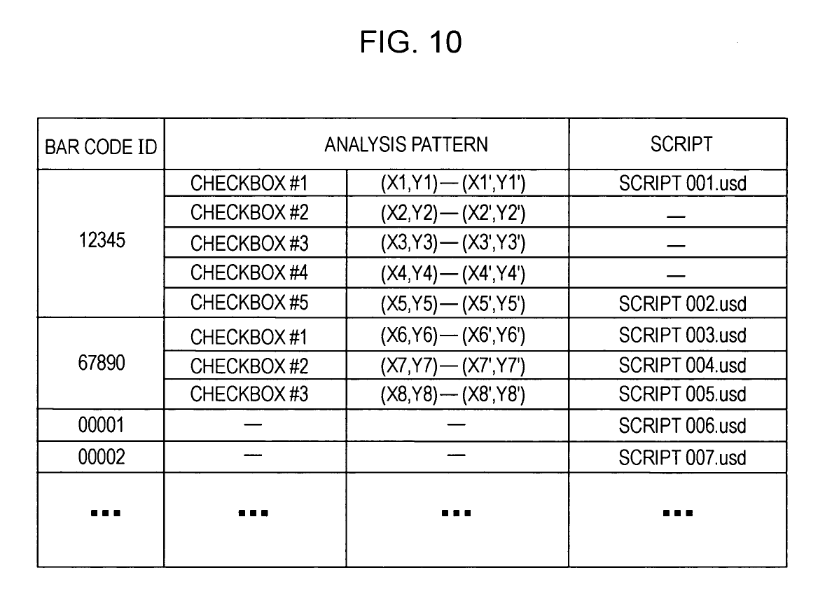

As described above, when a user inputs matching according to a screen change, as shown in FIG. 10, bar code IDs, analysis patterns, and scripts are matched, and are stored in a table. This table is stored in the flash memory 12, and is held even if supply of electric power to the MFT 1 is intercepted. Further, if a script stored in the removable memory 28 is selected on the screen 108, the selected script is copied to the flash memory 12 from the removable memory 28. If a script stored in the removable memory 28 is selected, the removable memory 28 may not be connected with a card slot (not shown) at the time of reception of a facsimile message. If a script stored in the removable memory 28 is selected, printing can be performed on the basis of the selected script whenever facsimile messages are received when copying of the script to the flash memory 12 is attempted.

FIG. 10 is a schematic diagram showing an example of the aforementioned table. The bar code ID input on the screen 102, the analysis pattern determined on the basis of the contents input on the screen 104, and the script input on screens 106 and 108 are matched and stored. For example, the coordinates of the regions to be analyzed 170, 172, 174, 176, and 178 for analyzing which checkbox is checked as shown in FIG. 9 is stored in the analysis pattern. In addition, as described above, a script may be assigned to a bar code ID and a checkbox number, and for example, a script may be assigned only according to a bar code ID. In that case, the screen 104 and the screen 106 are omitted in the aforementioned screen change.

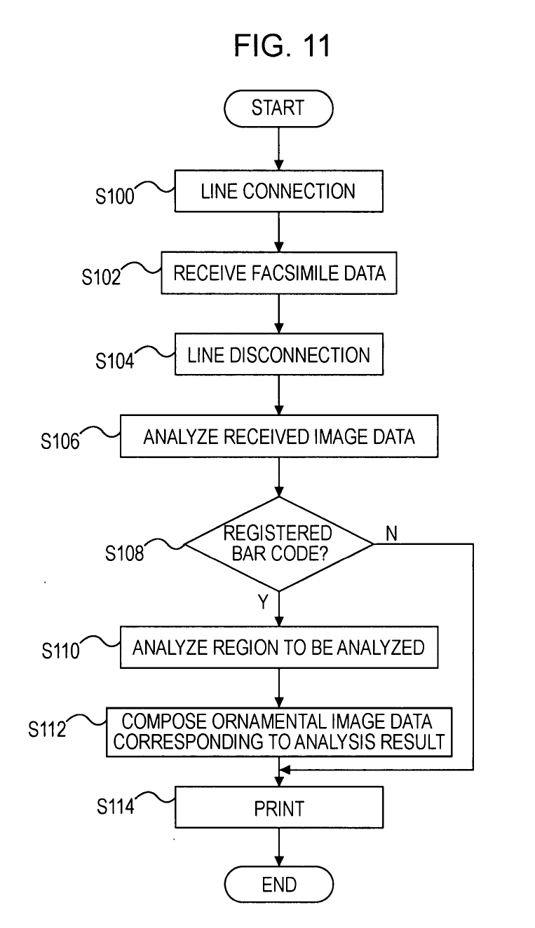

Next, the processing that the MFT 1 receives and prints facsimile data will be described. FIG. 11 is a flowchart showing the flow of the processing that the MFT 1 receives and prints facsimile data. This processing is started when the facsimile unit 24 detects an incoming call.

In Step S100, the facsimile unit 24 performs line connection in response to the incoming call. In this line connection, negotiation is performed according to a predetermined facsimile communication procedure between the facsimile unit 24 and a device of a source. In this negotiation, the facsimile unit 24 acquires receiving conditions, such as the telephone number of a source, image size, and color information, from a facsimile apparatus of the source.

In Step S102, the facsimile unit 24 receives facsimile data.

In Step S104, the facsimile unit 24 disconnects line connection.

In Step S106, the received image data is analyzed. Specifically, for example, the image data of an identification mark region 180 (refer to FIG. 9) is analyzed on the basis of identification information, and a bar code ID is detected. At this time, subsequent description will be continued on the assumption that “12345” is detected as the bar code ID.

In Step S108, it is determined whether or not the detected bar code ID is a registered ID. Specifically, it is determined whether or not the detected bar code coincides with any one of the bar code IDs stored in the aforementioned table. If the detected bar code coincides with any one of the registered IDS, the processing proceeds to Step S110. If the detected bar code does not coincide with any one of the registered IDs, the processing proceeds to Step S114.

In Step S110, regions to be analyzed are analyzed. Specifically, image data of the regions to be analyzed is analyzed on the basis of an analysis pattern matched with a bar code ID detected in Step S106. Here, description will be continued on the assumption that it is determined that the uppermost checkbox in the region to be analyzed 170, among the five checkboxes as shown in FIG. 9, is checked.

In Step S112, ornamental image data corresponding to the analysis results is composed. Specifically, for example, “SCRIPT 001.usd” that is stored so as to match “checkbox #1”, of the table shown in FIG. 10 is read from the analysis results in Step S110. The received image data is composed in a composition region of the ornamental image data defined in the above script, thereby generating composite image data. Next, the generated composite image data is assigned to a printing region virtually reproduced on the RAM 14 according to a layout defined in the above script.

In Step S114, the printing unit 18 prints an image on a print medium on the basis of the image data stored in the virtual printing region on the RAM 14. If data to which bar code IDs whose matching is not stored in the aforementioned table are assigned, and originals other than the questionnaire form, are received, printing is performed on a print medium in a predetermined layout similarly to a conventional facsimile apparatus.

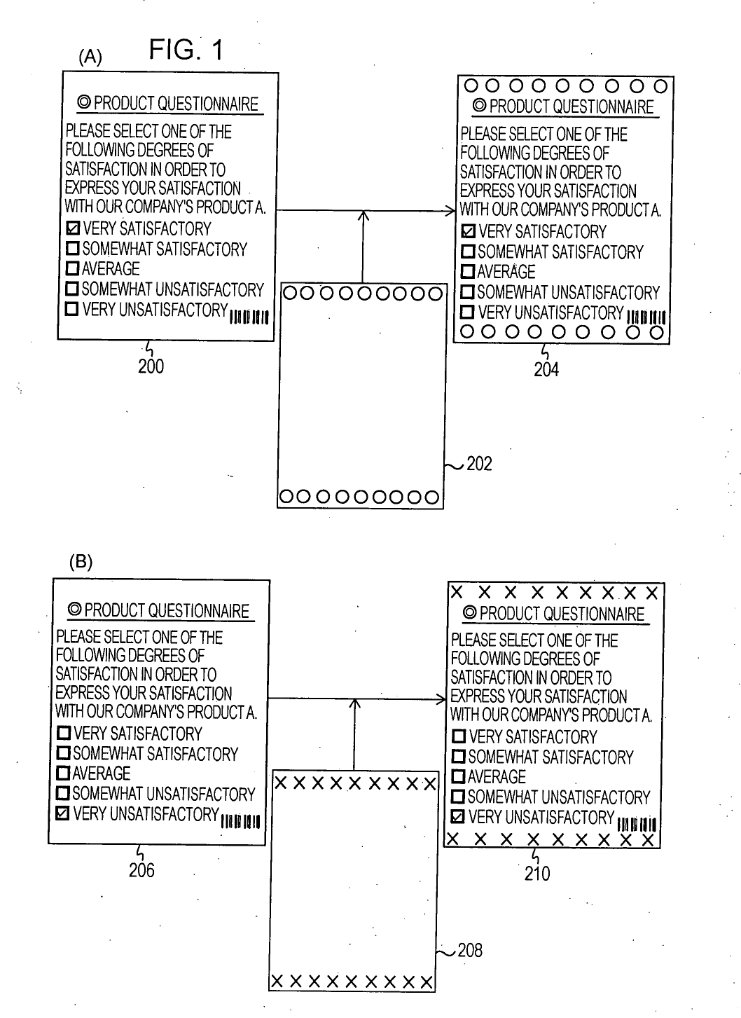

FIGS. 1A and 1B are schematic diagrams showing an example of a printing result. FIG. 1 shows an example when a questionnaire selected from five steps of evaluation is selected as a product questionnaire is received via facsimile. As shown in FIG. 1, according to the answers of the questionnaire, ornamental image data 202 and 208 that are different from each other are printed in combination with received image data 200 and received image data 206, respectively. Accordingly, the user of the MFT 1 can distinguish the contents of a received original at a glance by the difference between ornamental images. In addition, for example, if the printing unit 18 can print a color image, the color of ornamental image data can also be changed according to analysis results of received image data. When the color of the ornamental image data is changed, the user can easily distinguish the contents of a received original by color. Thus, print media on which the data that have been received via facsimile are printed can be more easily sorted.

In addition, the questionnaire form may not be a form that is created using a predetermined questionnaire-form creating application as mentioned above. For example, a questionnaire form created and printed in an arbitrary layout is input from the scanning unit 22. Next, read questionnaire form image data is displayed on the LCD unit 16, and an analysis pattern is input by making a user select a region to be analyzed among questionnaire form image data using the operation unit 27. Also, matching of a script according to the analysis result of a region to be analyzed, and a bar code ID given to a questionnaire form may be input. The MFT 1 may generate bar code image data on the basis of the input bar code ID, may assign the bar code image data to questionnaire form image data, and may make the printing unit 18 print the questionnaire form image data to which the bar code image data is assigned. A questionnaire form created in an arbitrary layout may be input to the MFT 1 from the external interface 29 or removable memory 28. The questionnaire form image data to which a bar code image is assigned may be transmitted to another facsimile apparatus 2 by the facsimile unit 24, or may be output via the RMC 26 or external interface 29 as electronic data. As described above, a user can create a questionnaire form to be used to easily sort questionnaires transmitted from other facsimile apparatuses.

The present invention is not limited to the above embodiment, and can be applied to various embodiments without departing the scope thereof. For example, a grade paper in a mark sheet format that has been received via facsimile may be stored so as to match an identification mark, an analysis pattern corresponding thereto, and right and wrong information on individual questions, and a figure that shows marks graded on the basis of the matching may be composed and printed.

What is claimed is:

1. A facsimile apparatus comprising:
communication means that transmits and receives facsimile data via a communication line;
analyzing means that analyzes received image data generated on the basis of the received facsimile data;
composite image data generating means that acquires ornamental image data according to analysis results of the received image data, and generates composite image data on the basis of the acquired ornamental image data and the received image data; and
composite image printing means that makes a printing unit print a composite image on the basis of the composite image data.

2. The facsimile apparatus according to claim 1,
wherein the analyzing means analyzes on the basis of identification information an identification mark region that is included in the received image data to identify the type of a transmission original form, and the composite image data generating means acquires the ornamental image data corresponding to analysis results of the identification mark region.

3. The facsimile apparatus according to claim 2,
wherein the analyzing means acquires an analysis pattern corresponding to the analysis results of the identification mark region, and analyzes regions to be analyzed outside the identification mark region of the received image data, on the basis of the acquired analysis pattern, and
the composite image generating means generates a composite image on the basis of the ornamental image data and the received image data corresponding to analysis results of the regions to be analyzed.

4. The facsimile apparatus according to claim 3, further comprising input means that allows the ornamental image data to be input thereto and allowing matching between the identification information and the ornamental image data to be input thereto,
the analyzing means analyzes the received image data on the basis of the matched identification information and analysis pattern, and
the composite image data generating means generates composite image data on the basis of the matched ornamental image data and received image data.

5. The facsimile apparatus according to claim 4, further comprising transmission image data generating means and transmission image data output means,
wherein the input means allows first transmission image data where the regions to be analyzed other than the identification mark region are laid out to be input thereto, and allows matching among the input first transmission image data, an analysis pattern of the first transmission image data, the ornamental image data, and the identification information to be input thereto,
the transmission image data generating means generates second transmission image data on the basis of the identification mark region and the first transmission image data, and on the basis of the identification information matched with the first transmission image data, and
the transmission image data output means makes the printing unit print an image corresponding to the second transmission image data.

6. The facsimile apparatus according to claim 5,
wherein the transmission image data output means transmits the second transmission image data to the communication means.

7. A method of receiving facsimile data via a communication line, the method comprising: analyzing received image data generated on the basis of the received facsimile data;
acquiring ornamental image data according to analysis results of the received image data, and generating composite image data on the basis of the acquired ornamental image data and the received image data; and
making a printing unit print a composite image on the basis of the composite image data.
